(19) United States
(12) Patent Application Publication
(10) Pub. No.: US 2026/0238532 A1
(43) Pub. Date: Aug. 13, 2026

(54) OVERHEARING OF REFERENCE SIGNALS

(71) Applicant: TELEFONAKTIEBOLAGET LM ERICSSON (PUBL), Stockholm (SE)

(72) Inventors: Florent MUNIER, Västra Frölunda (SE); Satyam DWIVEDI, SOLNA (SE); Gustav LINDMARK, Linköping (SE); Ritesh SHREEVASTAV, Upplands Väsby (SE); Peter HAMMARBERG, MÖLNDAL (SE); Xiaolin JIANG, LINKÖPING (SE)

(73) Assignee: TELEFONAKTIEBOLAGET LM ERICSSON (PUBL), Stockholm (SE)

(21) Appl. No.: 19/156,400

(22) PCT Filed: Jan. 24, 2024
(86) PCT No.: PCT/EP2024/051622

§ 371 Date: Aug. 14, 2025

Related U.S. Application Data
(60) Provisional application No. 63/446,169, filed on Feb. 16, 2023.

(51) Int. Cl. H04L 27/26; H04W 64/00; H04W 72/25

(52) U.S. Cl. CPC H04L 27/261; H04W 64/00; H04W 72/25

(57) ABSTRACT

According to some embodiments, a method of operating a first entity in a communications network that includes a second entity, a third entity, and a fourth entity is provided. The method includes receiving (1210) configuration information associated with a reference signal, RS, to be transmitted by the second entity to the third entity.

The method further includes overhearing (1220) the RS using the configuration information. The method further includes transmitting (1230) a message to a fourth entity based on overhearing the RS.

### TECHNICAL FIELD

Embodiments herein relate to an entity and methods therein. In some aspects, they relate to operating a first entity in a communications network.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

NR currently supports the following radio access technology (“RAT”) dependent positioning procedures: 1) Downlink time-difference-of-arrival (“DL-TDOA”); 2) Multi-round trip time (“RTT”); 3) Uplink time-difference-of-arrival (“UL-TDOA”); 4) Downlink angle-of-departure (“DL-AoD”); 5) Uplink angle-of-arrival (“UL-AoA”); and 6) NR enhanced cell identifier (“E-CID”).

The DL TDOA positioning procedure makes use of the downlink (“DL”) reference signal time difference (“RSTD”) (and optionally DL positioning reference signal (“PRS”) reference signal received power (“RSRP”)) of downlink signals received from multiple transmission points (“TPs”), at the UE. The UE measures the DL RSTD (and optionally DL PRS RSRP) of the received signals using assistance data received from the positioning server, and the resulting measurements are used along with other configuration information to locate the UE in relation to the neighboring TPs.

The Multi-RTT positioning procedure makes use of the UE reception (“Rx”)-transmission (“Tx”) measurements and DL PRS RSRP of downlink signals received from multiple transmission/reception points (“TRPs”), measured by the UE and the measured gNB Rx-Tx measurements and UL sounding reference signal (“SRS”)-RSRP at multiple TRPs of uplink signals transmitted from UE.

The UL TDOA positioning procedure makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

The DL AoD positioning procedure makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The UL AoA positioning procedure makes use of the measured azimuth and zenith of arrival at multiple reception points (“RPs”) of uplink signals transmitted from the UE. The RPs measure A-AoA and Z-AoA of the received signals using assistance data received from the positioning server, and the resulting measurements are used along with other configuration information to estimate the location of the UE.

NR E-CID positioning refers to techniques that use additional UE measurements and/or NR radio resource and other measurements to improve the UE location estimate.

The positioning modes can be categorized into three areas: 1) UE-Assisted; 2) UE-Based; and 3) Standalone. UE-Assisted can refer to the UE performing measurements with or without assistance from the network and sending these measurements to the evolved serving mobile location center (“E-SMLC”) where the position calculation may take place. UE-Based can refer to the UE performing measurements and calculating its own position with assistance from the network. Standalone can refer to the UE performing measurements and calculating its own without network assistance.

The 3^{rd} Generation Partnership Project (“3GPP”) specified the Long Term Evolution (“LTE”) device-to-device (“D2D”) technology (also known as Proximity Services (“ProSe”)). LTE vehicle-to-anything (“V2X”) describes related enhancements targeting the specific characteristics of vehicular communications. The NR V2X mainly targets advanced V2X services, which can be categorized into four use case groups: vehicles platooning, extended sensors, advanced driving, and remote driving. The advanced V2X services can require enhancements of the NR system and a new NR sidelink framework could help to meet the stringent requirements in terms of latency and reliability. NR V2X systems are also expected to have higher system capacity, better coverage, and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast, and unicast transmissions. Furthermore, NR sidelink is designed in such a way that its operation is possible with and without network coverage and with varying degrees of interaction between the UEs and the network (“NW”), including support for standalone, network-less operation.

National Security and Public Safety (“NSPS”) services may need to operate with partial or without NW coverage, such as indoor firefighting, forest firefighting, earthquake rescue, and sea rescue. where the infrastructure is (partially) destroyed or not available, therefore, coverage extension is a crucial enabler for NSPS, for both NSPS services communicated between UE and cellular NW and that communicated between UEs over sidelink. A system identifier (“SID”) on NR sidelink relay can be used to further explore coverage extension for sidelink-based communication, including both UE to NW relay for cellular coverage extension and UE to UE relay for sidelink coverage extension.

FIGS. 2A-C illustrate examples of a pair of UEs in full coverage (FIG. 2A), partial coverage (FIG. 2B), and out of coverage (FIG. 2C). UEs that are in coverage of a gNB rely on configuration (through a radio resource control (“RRC”) and/or a system information block (“SIB”)). UEs that are out of coverage rely on a (pre-)configuration available in the subscriber identity module (“SIM”) of the device. In some examples, pre-configuration is (semi-)static and updates are possible (when the UE is in coverage).

A Positioning Reference Unit (“PRU”) at a known location can perform positioning measurements (e.g., RSTD, RSRP, and UE Rx-Tx Time Difference measurements) and report these measurements to a location server. In addition, the PRU can transmit SRS to enable TRPs to measure and report UL positioning measurements (e.g., RTOA, UL-AoA, and gNB Rx-Tx Time Difference) from PRU at a known location. The PRU measurements can be compared by a location server with the measurements expected at the known PRU location to determine correction terms for other nearby target devices. The DL-and/or UL location measurements for other target devices can then be corrected based on the previously determined correction terms. From a location server perspective, the PRU functionality is realized by a UE with known location.

### SUMMARY

There currently exist certain challenges. For example, there are currently no positioning specific signals available for sidelink transmission/reception. The “/” when used herein may e.g. mean “and/or”. In some examples, sidelink signals may be limited in positioning performance compared to uplink or downlink signals due to the restriction on the sidelink spectrum. In additional or alternative examples, for UEs that are under control of the network, such as a UE within coverage of a base station (gNB), it is still possible to transmit the SRS signal. This signal can be measured at another UE if this UE was able to demodulate it. This is currently not possible since a UE is not aware of the SRS configuration of another UE.

A sidelink (“SL”) positioning reference signal (“SL-PRS”) may be specified to be used for measurements between UEs. As the coverage of sidelink is limited and furthermore there may not be several UEs available to be involved for ranging measurements; it would be beneficial if a base station is also involved in the ranging process. Currently, the signaling/procedure does not allow that.

An object of embodiments herein is to improve SL positioning in a communications network.

According to some embodiments, a method of operating a first entity in a communications network that includes a second entity, a third entity, and a fourth entity is provided. The method includes receiving configuration information associated with a reference signal, RS, to be transmitted by the second entity to the third entity. The method further includes overhearing the RS using the configuration information. The method further includes transmitting a message to a fourth entity based on overhearing the RS.

According to other embodiments, a method of operating a first entity in a communications network that includes a second entity, a third entity, and a fourth entity is provided. The method includes transmitting configuration information to a second entity, the configuration information associated with a reference signal, RS, to be transmitted by the third entity to the fourth entity. The method further includes receiving a message from the second entity, the message including information associated with the second entity overhearing the RS using the configuration information.

According to other embodiments, a communication device, a network node, a LMF, a PRU, a system, a host, a computer program, a computer program product, or a non-transitory computer readable medium is provided to perform at least one of the above methods.

Certain embodiments may provide one or more of the following technical advantages. In some embodiments, an existing reference signal for uplink (UE to network) positioning can be reused for UE to UE positioning, thus lowering RS overhead for positioning and freeing resources for (e.g., communication). In additional or alternative embodiments, a better quality of service can be provided for the UE-to-UE measurements, as compared to measurements performed on SL-PRS where collisions and high interference are more likely.

In additional or alternative embodiments, the network is enabled to assist device-to-device positioning, which would otherwise be out of the network control, thus giving a more central role to the network.

In additional or alternative embodiments, the procedures described herein can be scaled to a set of UEs.

In additional or alternative embodiments, the gNB listening/overhearing SL-PRS mechanism can enable the collection of extra measurements to improve SL positioning/ranging accuracy or can act as authentication for the SL positioning/ranging result. In some examples, if gNB measuring SL-PRS is used as a replacement for SRS measurement, Uu resources are saved.

In additional or alternative embodiments, the PRU listening/overhearing SL-PRS mechanism enable to collect extra measurements to improve SL ranging accuracy.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIGS. 2A-C are schematic diagrams illustrating examples of a pair of UEs being in different coverages;

FIG. 3 is a schematic diagram illustrating an example of sidelink communication configured for UE positioning in accordance with some embodiments;

FIGS. 4-6 are signal flow diagrams illustrating examples of a UE overhearing UL SRS in accordance with some embodiments;

FIGS. 7-8 are signal flow diagrams illustrating examples of a network node overhearing SL-PRS in accordance with some embodiments;

FIGS. 9-10 are signal flow diagrams illustrating examples of a PDU overhearing SL-PRS in accordance with some embodiments;

FIG. 11 is a table illustrating an example of an IE including SRS configuration information in accordance with some embodiments;

FIGS. 12-13 are flow charts illustrating examples of operations performed by an entity in accordance with some embodiments;

FIG. 14 is a block diagram of a communication system in accordance with some embodiments;

FIG. 15 is a block diagram of a user equipment in accordance with some embodiments;

FIG. 16 is a block diagram of a network node in accordance with some embodiments;

FIG. 17 is a block diagram of a host, which may be an embodiment of the host of FIG. 14, in accordance with some embodiments;

FIG. 18 is a block diagram of a virtualization environment in accordance with some embodiments; and

FIG. 19 shows a communication diagram of a host communicating via a network node with a user equipment over a partially wireless connection in accordance with some embodiments.

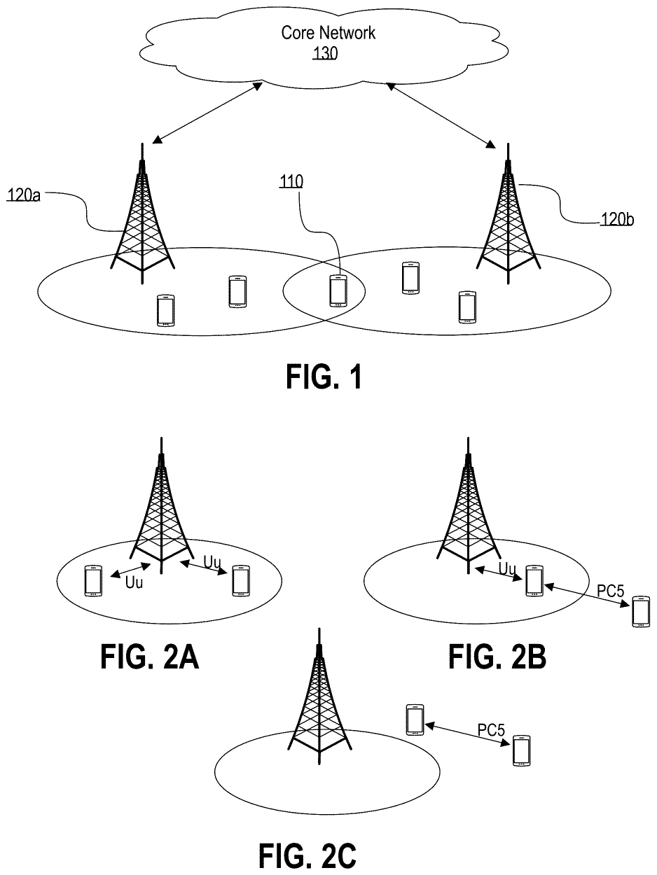

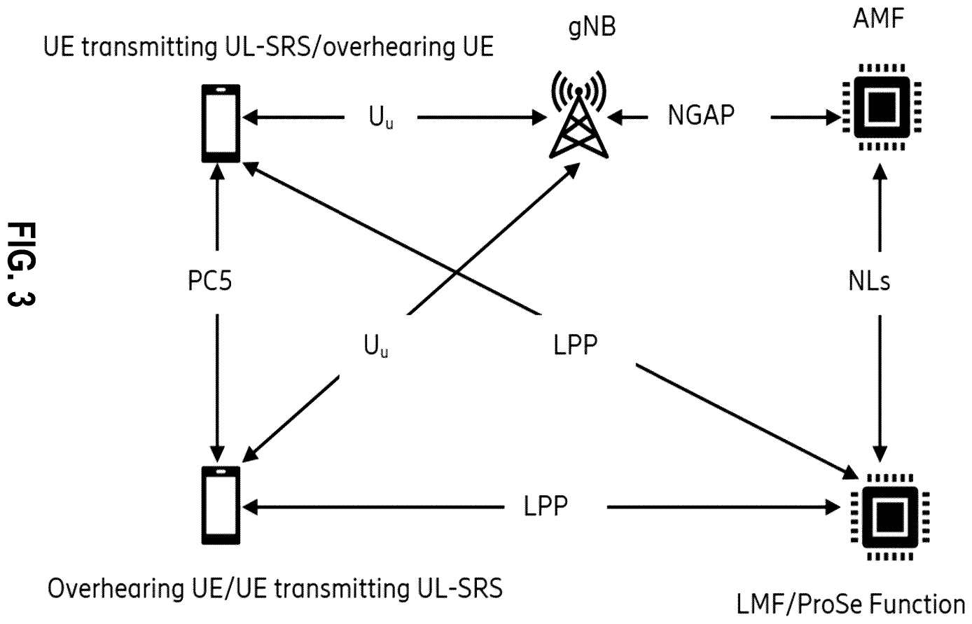

### DETAILED DESCRIPTION

Some example embodiments herein relate to methods to configure a sounding reference signal and sidelink positioning reference signal receptions for overhearing positioning.

The present disclosure is related to wireless communication systems and more particularly to configuring a sounding reference signal (“SRS”) and sidelink (“SL”) positioning reference signal (“PRS”) reception for overhearing aided positioning.

Certain aspects of the disclosure and their embodiments may provide solutions to these or other challenges. In some embodiments, when a UE transmitting SL-PRS is within coverage of a base station (gNB), and if the gNB has knowledge of the SL-PRS configuration, the gNB can perform measurements based on the SL-PRS. Such measurements can improve SL positioning performance or save Uu resource when both Uu and PC5 measurements are requested. PC5 when used herein e.g. means/refers to the sidelink interface between a first transmitting UE and another receiving UE, and Uu when used herein e.g. refers to the interface between a gNB and a UE, as defined by 3GPP in TS 38.305 V18.0.0 (2023-12). Various embodiments herein provide mechanisms to request the gNB to perform measurements based on a SL-PRS.

Similarly, for UL-SRS transmission either in non-sidenlink scenario or in sidelink scenario; if another UE overhears the UL-SRS transmission; it can improve the positioning accuracy as several UEs can be involved. Some embodiments address two problems: 1) Mechanisms to allow for a UE to measure and report on an uplink SRS transmission made by another UE to a gNB; and 2) Mechanisms to allow for a gNB or another UE to measure and report on a SL-PRS transmission from one UE to another.

The term overhearing can be used herein to refer to when a reference signal has one or multiple intended recipients, but another, unintended node (e.g., a UE or TRP) also performs measurements on it. The other node can be described as overhearing. In some examples, overhearing is when a device is listening to the communication between two or more other devices (without actively taking part), potentially without their knowledge. For positioning, this can correspond to measurements performed by a first device on a reference signal transmitted by a second device which is part of a positioning procedure with a third device.

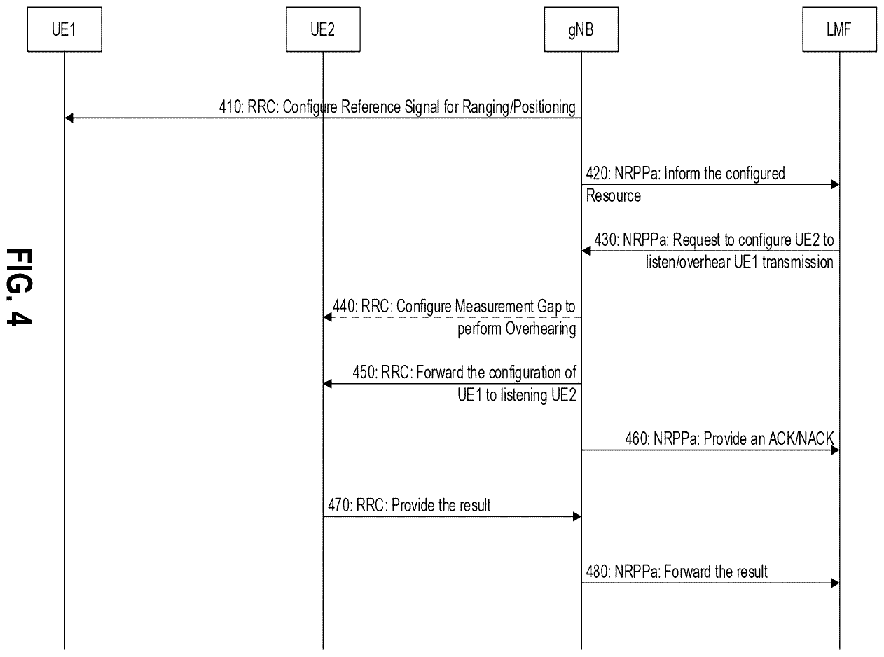

FIG. 3 illustrates an example of a schematic for sidelink communication configured for UE positioning.

In some embodiments, SRS overhearing is enabled in a positioning scenario for (both normal coverage (non-sidelink) and also for sidelink) UEs, by specifying a configuration forwarding mechanism. In some examples, the configuration forwarding mechanism can include: 1) A transmitting UE being configured with SRS in a serving cell A; 2) The gNB for serving cell A forwarding the SRS configuration to the LMF upon request from the LMF; and 3) The overhearing UE requesting the LMF for SRS configurations from the transmitting UEs via LPP request.

In additional or alternative examples, the NW node (e.g., a location management function (“LMF”), gNB, or ProSe function) identifies another UE in the vicinity. The NW entity configures this UE to overhear the UL SRS transmission. In additional or alternative examples, the interface between the TRP and the LMF to transfer the SRS configuration between a gNB and the LMF is already specified. The LMF may relay the request to the gNB “owning” the SRS configuration, in order to secure that the overhearing UE is allowed to listen to the SRS configuration. Alternatively, the gNB may signal to the LMF that configurations shared by the gNB are authorized to be shared for overhearing purposes. Such authorization may be signalled as part of the SRS configuration or in a dedicated message from the gNB to the LMF. The dedicated message can include a list of SRS configuration IDs, corresponding to the SRS configuration previously provided to the LMF, that are authorized to be used for overhearing purpose. The dedicated message can also include, for each configuration, a list of UE IDs for which overhearing is authorized. If no ID is provided, the LMF may assume the SRS configuration authorized for overhearing may be shared to any UE. In additional or alternative examples, a dedicated bit to signal whether the configuration can be used of overhearing is added in the SRS configuration information when provided to the LMF.

In additional or alternative examples, the LMF provides the SRS configuration to the overhearing UE in a LTE positioning protocol (“LPP”) assistance data message. In additional or alternative examples, the LMF requests the transmitting UE to forward the SRS configuration to the overhearing/monitoring UE by other means (e.g., via a sidelink positioning protocol (“SLPP”). The monitoring UE can be positioning reference unit (“PRU”) or any assistant UE.

In additional or alternative embodiments, SL-PRS overhearing is enabled in a positioning scenario for gNBs, by specifying a configuration forwarding mechanism.

In some examples, SL-PRS(s) is configured by the NW, and the gNB is aware of it. Only a measurement request may be required (e.g., the LMF requests gNB to measure on SL-PRS). In additional or alternative examples, the SL-PRS resources are owned by the serving g-NB configuring them. The gNB may elect to not share these resources. Therefore, if the measuring gNB is not the serving gNB owning the resource for SL PRS, the LMF may either request authorization to the gNB, or have received it in advanced as part of the SL PRS configuration, similar to what is described above for SRS.

In additional or alternative examples, SL-PRS(s) of the UEs are reserved autonomously. The UE may forward the reserved SL-PRS configuration to gNB (e.g., using RRC signaling).

In additional or alternative examples, the SL PRS configurations have being pre-loaded in the listening gNB and/or the LMF at an earlier stage. The UE may only signal which configuration to measure (e.g., by sending the SL PRS ID). The UE may forward the reserved SL-PRS configuration, or configuration ID to the LMF, and the LMF may further forward it to the gNB and request the gNB to measure on the SL-PRS.

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The applicable scenarios to enable SRS overhearing by SL UEs include in-coverage and partial coverage cases, where at the least the UE to be configured with an SRS is in coverage of a gNB. The procedure may be initiated by the transmitting UE, for example, under the condition that no SL resources are available (to achieve quality of service (“QoS”) for SL ranging or positioning). The procedure may also be initiated by the LMF. After receiving a location service (“LCS”) request for ranging from an external application between two UEs, the LMF can request measurements for hybrid positioning or UE-UE/PC5 only positioning/ranging, and transmit a request to the gNB to schedule the transmitting UE to use SRS for UE-UE measurement.

In some embodiments, the measuring UE can be configured with an SRS. In some examples, the transmitting UE requests the serving gNB to be configured with an SRS resource for the purpose of overhearing. The request may include an indicator that overhearing will be used, and may also include the UE ID of the measuring UE to assist the gNB finding a suitable SRS configuration.

In additional or alternative embodiments, the measuring UE can request the SRS (either the SRS for positioning or the SRS for communication) configuration to be provided.

In some examples, the request is carried by RRC signaling to the serving gNB directly. In additional or alternative examples, the request is conveyed to the LMF, which in turn requests the gNB to provide the SRS configuration.

In additional or alternative embodiments, the LMF requests the gNB to configure the transmitting UE with an SRS suitable for overhearing. The request may be implemented by an extension of the existing SRS request but also a separate message may be used. The message may include the ID of the measuring UE to assist the gNB in finding a suitable configuration.

In additional or alternative embodiments, the UE may add the frequencies supported by the monitoring/overhearing UE when sending requests for SRS configuration to the gNB, or forward such information to the LMF when sending the capability of the monitoring/overhearing UE. The LMF can then forward such information to the gNB when requesting the gNB to configure the SRS. Then the gNB can consider the information when configuring SRS for the transmitting UE.

In additional or alternative embodiments, the SRS request from the LMF to the TRP can be part of an UL measurement procedure (e.g., for multi RTT or UL-TDOA), where the gNB also measures on the SRS. In additional or alternative embodiments, the SRS request is independent from the gNB UL measurements (e.g., only used for overhearing measurements between UE). The gNB can report the SRS configuration via NR Positioning Protocol A (NRPPa) to the LMF.

Once the LMF has obtained the SRS configuration, the configuration may be forwarded to the measuring UE via LPP. In some examples, for the partial coverage, the SRS is forwarded to the measuring UE by the transmitting UE via a PC5 interface In additional or alternative examples, the SRS configuration can include configurations so that the SRS timing can be understood by the listening UE, in case the listening UE is not aware of the transmitting UE UL frame timing.

Once the UE has received the SRS, it may forward UL measurements to the LMF. In some examples, the following measurements are defined for UE overhearing of the SRS:

Receiving UE SRS RSRP; Receiving UE SRS RSRPP; Receiving UE Rx-Tx time difference; and Receiving UE time of arrival relative UL or DL timing In additional or alternative examples, UE based positioning is enabled by the receiving UE and the gNB reporting the above measurements to the transmitting UE. The reports may first be sent to the LMF, which can then forward them to the UE. The receiving UE location can be shared as part of the report.

In some embodiments, to enable SL-PRS overhearing by the gNB, the UEs must be in-coverage or in partial coverage. The applicable scenarios to enable SL-PRS overhearing by PRU include in-coverage and partial coverage scenarios when LMF make the overhearing request; and when target UE requests for the overhearing of PRU all coverage scenarios apply including in-coverage, partial coverage, and out-of-coverage.

The SL-PRS of the UE can be configured by two schemes: 1) SL-PRS(s) is configured by the NW; and 2) SL-PRS(s) of the UEs are reserved autonomously. In some examples, the gNB is requested by LMF to measure on SL-PRS. In an additional or alternative example, the gNB being requested by the LMF to measure SL-PRS can be part of an UL measurement procedure (e.g., for multi RTT or SL-TDOA) where gNB measures SL-PRS instead of SRS.

In some examples, the gNB can know the SL-PRS if configured or the configuration is shared with the gNB by the LMF. In additional or alternative examples, the gNB may request the SL-PRS configuration from the UE directly or the LMF may request the SL-PRS configuration from the UE and forward them to the gNB. In additional or alternative examples, the SL PRS configurations are pre-loaded in the listening gNB and/or the LMF at an earlier stage. The UE only signals which configuration to measure (e.g., by sending the SL PRS ID).

The gNB can measure SL-PRS and report the measurement to the LMF. In some examples, the following measurements are defined for gNB overhearing of the SL-PRS: SL-PRS RSRP; SL-PRS RSRPP; gNB Rx Tx; and time of arrival relative UL timing.

In some embodiments, UE based positioning is enabled by the receiving UE and the gNB reporting the above measurements to the transmitting UE. The reports may first be sent to the LMF, which then forwards them to the UE. Additionally, the receiving UE location can be shared as part of the report.

In additional or alternative embodiments, the PRU is requested by LMF or by target UE to measure on SL-PRS. The SL-PRS configuration for the PRU to overhear can be forwarded by LMF in LPP Assistance Data message or can be sent by target UE. The PRU measures SL-PRS and reports the measurement to LMF or to the target UE. In additional or alternative embodiments, the following measurements are defined for PRU overhearing of the SL-PRS: SL-PRS RSRP; SL-PRS RSRPP; PRU/UE Rx-Tx; and time of arrival, relative time of arrival based upon SL reference signal.

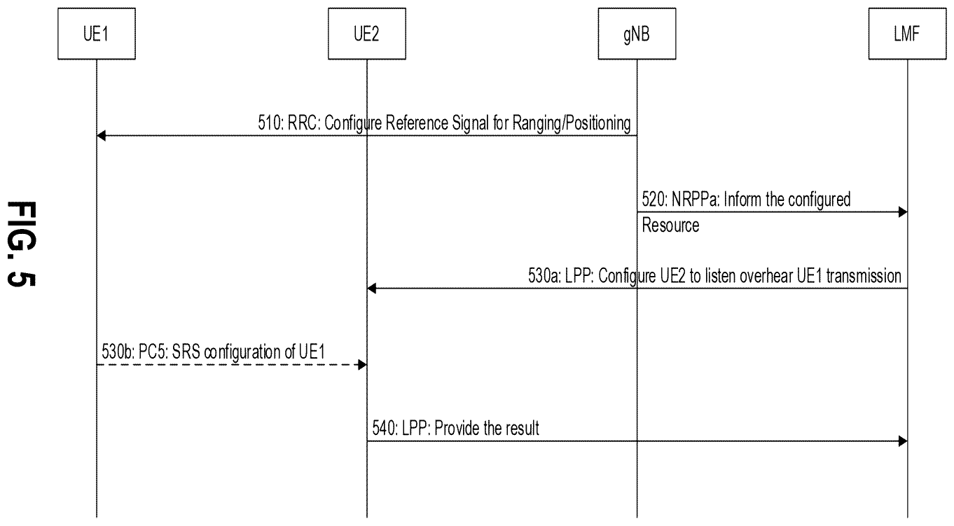

FIG. 4 illustrates an example of signals communicated during UE overhearing of UL SRS including configuration via a gNB (also referred to herein as a network node). At block 410, the gNB configures reference signal for ranging or positioning purpose. The gNB may receive the request to configure such via Location server Node (LMF). At block 420, the gNB reports the configured resource to LMF. At block 430, the LMF requests the gNB configure UEs for performing overhearing/listening. At block 440, the gNB may configure a measurement gap to facilitate in performing overhearing. At block 450, the RRC provides UE2 the configuration of UE1 to perform listening, also referred to as monitoring and/or overhearing of SRS transmission. At block 460, the gNB provides results to the LMF. At block 470, the listening/overhearing UE provides the result to gNB, e.g. Acknowledgement (ACK) or Non-Acknowledgement (NACK). At block 480, the gNB provides the result to LMF and the LMF computes the position using the obtained result and other parameters such as gNB co-ordinates.

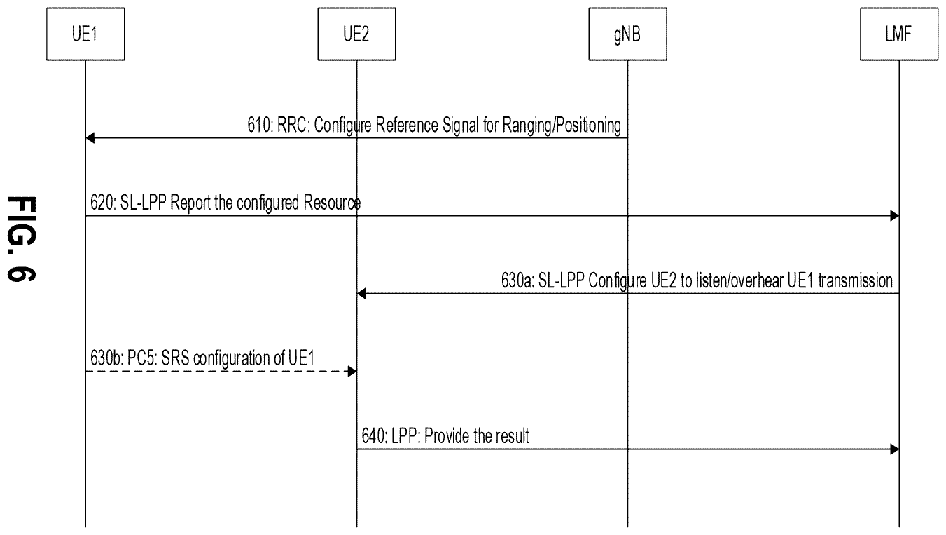

FIG. 5 illustrates an example of signals communicated during UE overhearing of UL SRS including configuration via a LMF (which may be provided by a serving network node (e.g., a Radio Access Network (RAN) node), a neighbor node, or a core network node,). In this example, UE2 is out of coverage or in coverage of another gNB (e.g., UE2 does not require any measurement gap or is not directly communicating to gNB over Uu). The LMF may directly configure the UE2 for listening as illustrated.

At block 510, the gNB configures reference signal for ranging or positioning purpose. The gNB may receive the request to configure such via Location server Node (LMF). At block 520, the gNB reports the configured resource to LMF. At block 530a (in addition or alternatively to block 530b), the LMF provides the configuration of UE2 to listening/overhearing UE1. At block 530b (in addition or alternatively to block 530a), the LMF may request UE1 to forward its SRS configuration to UE2 and request the other UE to measure (overhear). This signaling exchange can be performed via PC5. At block 540, the UE provides results to the LMF and the LMF computes the position using the obtained result and other parameters such as gNB co-ordinates.

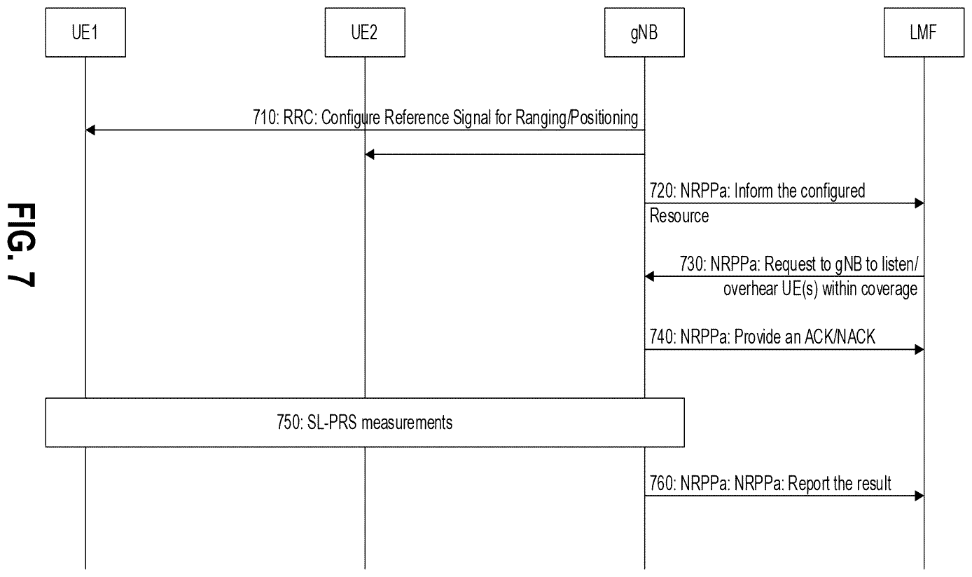

FIG. 6 illustrates an example of signals communicated during UE overhearing of UL SRS including configuration via a SL-LMF (which may be provided by another communication device). At block 610, the gNB configures reference signal for ranging or positioning purpose. The gNB may receive the request to configure such via Location server Node (LMF). At block 620, UE1 reports the configured resource to the SL-LMF. At block 630a (in addition or alternatively to block 630b), the SL-LMF provides the configuration of UE2 to listening/overhearing UE1. At block 630b (in addition or alternatively to block 630a), the SL-LMF may request UE1 to forward its SRS configuration to UE2 and request UE to measure via PC5. At block 640, the UE provides results to the SL-LMF and SL-LMF computes the position using the obtained result and other parameters such as UE coordinates.

In some embodiments, the SL-LMF is implemented inside UE1 (e.g., UE1 acts as Sidelink UE location server which has the capability similar to NW node LMF. In additional or alternative embodiments, a UE which receives an SRS configuration, forwards this configuration to another node or UE, or a specific UE where UE can have different role including UE location server.

FIG. 7 illustrates an example of signals communicated during gNB overhearing of SL-PRS including NW controlled allocation of SL-PRS configurations (e.g., when the UE is within coverage or partial coverage). At block 710, the gNB configures SL-PRS for UE(s) within coverage for ranging or positioning purpose. The gNB may receive the request to configure such via Location Server Node (LMF). At block 720, the gNB reports the configured resource(s) to LMF. At block 730, the LMF requests the gNB to measure on SL-PRS transmitted by UE(s) within coverage. Such measurements may act as extra measurements or replace SRS measurements in the multi-RTT or hybrid SL-TDOA procedures. At block 740, the gNB replies to the request by the LMF. At block 750, the gNB measures SL-PRS transmitted by the UE(s) within coverage. At block 760, the gNB sends the measurement result(s) to LMF.

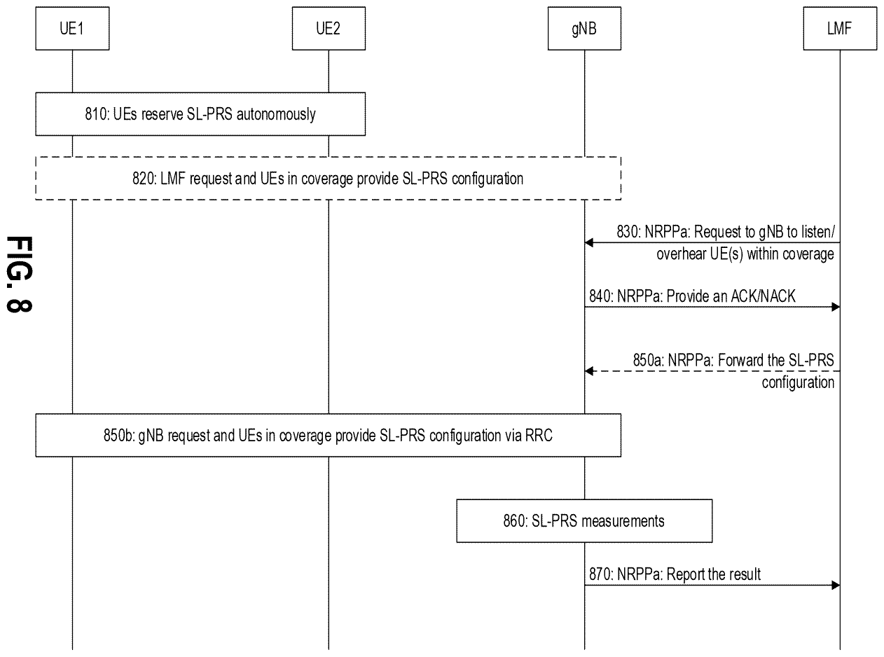

FIG. 8 illustrates an example of signals communicated during gNB overhearing of SL-PRS including UE autonomous configuration of SL-PRS (e.g., when the UE is outside of coverage). At block 810, the UEs performing SL positioning/ranging reserve SL-PRS autonomously. At block 820, the LMF may request for UEs that are in coverage to send their SL-PRS configuration, and UEs provide LMF the SL-PRS configuration. At block 830, the LMF requests the gNB to measure SL-PRS transmitted by the UEs that is in coverage. Such measurements may act as extra measurements or replace SRS measurements in the multi-RTT or hybrid SL-TDOA procedures. At block 840, the gNB replies to the request of the LMF. At block 850, the LMF may forward the SL-PRS configuration to gNB, or gNB request UEs directly for the SL-PRS configuration. At block 860, the gNB measures SL-PRS transmitted by the UE within coverage. At block 870, the gNB sends the measurement results to the LMF.

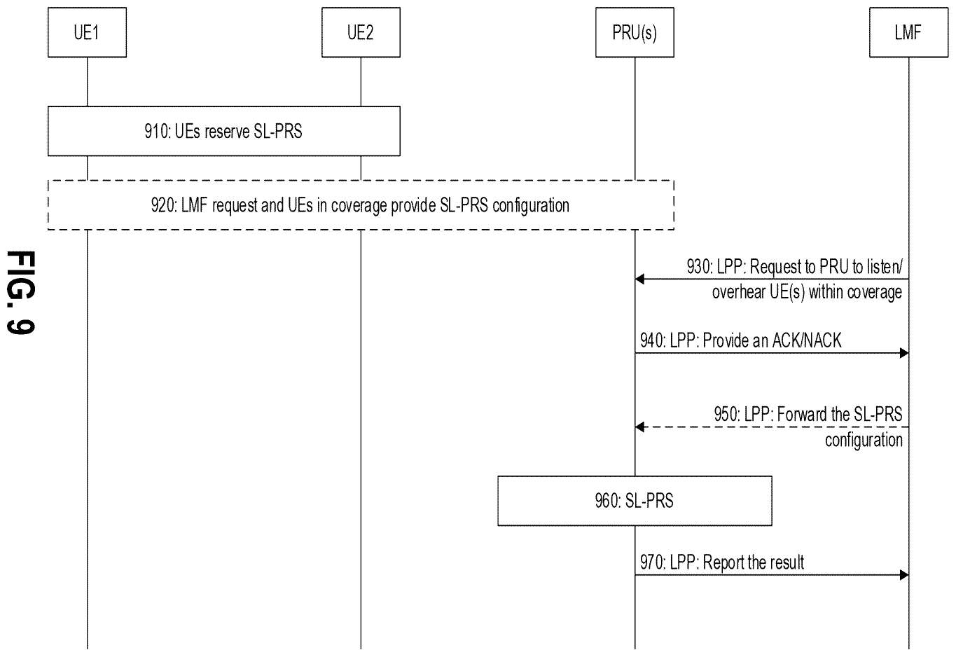

FIG. 9 illustrates an example of signals communicated during PRU overhearing of SL-PRS including the LMF requesting PRU to overhear. At block 910, the UEs perform SL positioning/ranging reserve SL-PRS by either scheme. At block 920, the LMF requests for UEs that are in coverage to send their SL-PRS configuration, and UEs provide LMF the SL-PRS configuration. At block 930, the LMF requests PRU to measure SL-PRS transmitted by the UEs via LPP. At block 940, the PRU replies to the request of LMF via LPP. At block 950, the LMF forwards the SL-PRS configuration to PRU. At block 960, the PRU measures SL-PRS. At block 970, the PRU sends the measurement results to LMF.

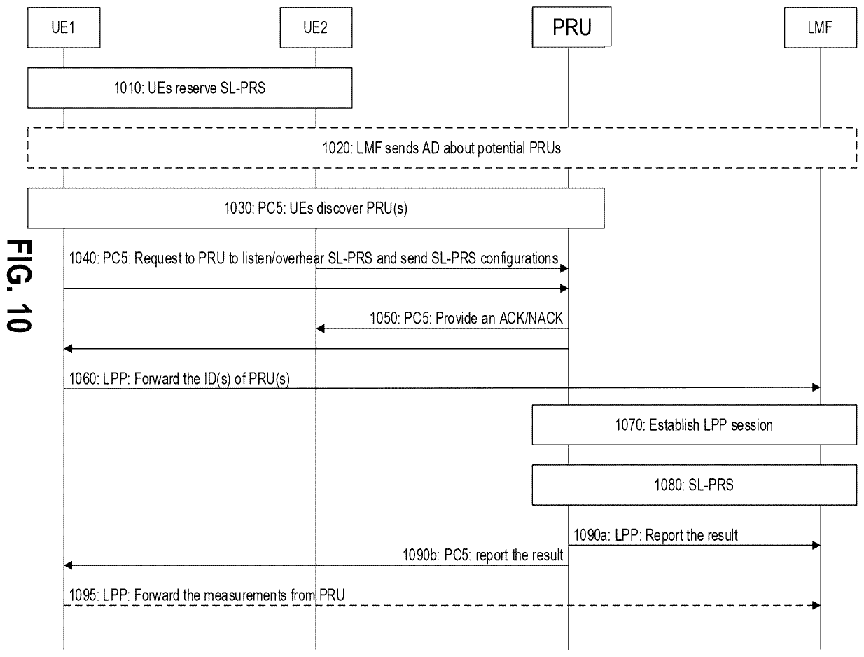

FIG. 10 illustrates an example of signals communicated during PRU overhearing of SL-PRS including the target UE requests the PRU to overhear. At block 1010, the UEs perform SL positioning/ranging reserve SL-PRS by either scheme. At block 1020, the LMF may send potential PRUs to the target UEs. At block 1030, target UEs discover the PRUs if they have not done it from previous SL communication or SL positioning. At block 1040, the target UEs request PRU to measure/overhear SL-PRS and send the SL-PRS configuration via PC5. At block 1050, the PRU replies to the request from the target UE.

If the ranging/SL positioning result is to be collected by LMF then, at block 1060, the target UE forward the L2 ID or Application ID to LMF. At block 1070, the LMF retrieves the SUPI of PRU with the help of AMF. The LMF establishes a LPP session with PRU.

At block 1080, the PRU measures SL-PRS. At block 1090a, the PRU sends the measurement results to LMF and/or at block 1090b the PRU sends the measurement results to the target UE based on the request received from LMF or target UE. At block 1095, if block 1090b is performed, target UE may forward the measurements to LMF and the information about PRU including PRU's location. In this case, blocks 1060 and 1070 are not required.

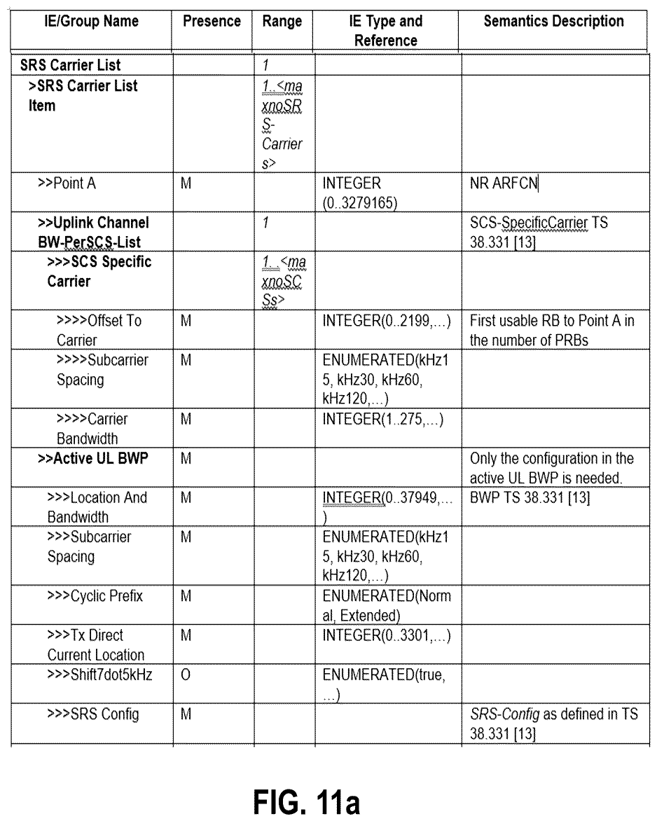

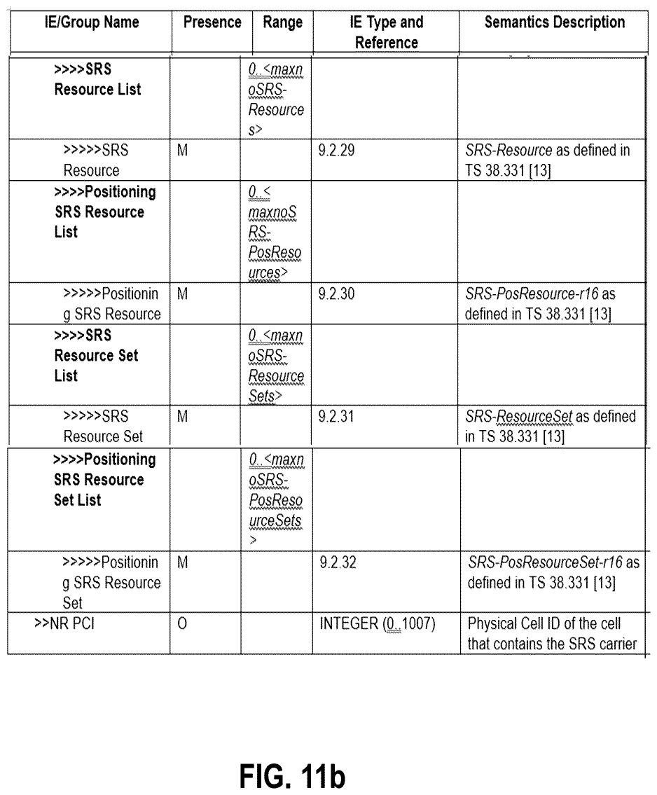

In terms of signaling implementation, the information element (“IE”) illustrated in FIG. 11a continuing in FIG. 11b (which includes SRS configurations configured by the gNB) is provided to LMF using existing NRPPa. The enhancement introduced by these innovations can be used in this SRS configuration and be provided to other UEs via an LPP signaling.

Similarly for SL-PRS configuration, the configured SL-PRS configuration for a UE can be relayed by LPP to some other UE for the in-coverage or partial coverage scenario where LMF is involved for SL operation.

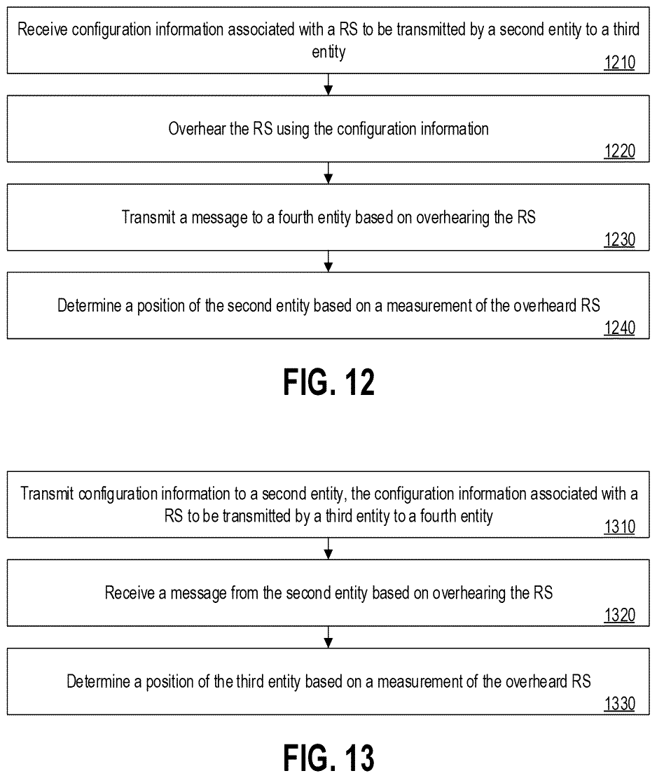

Operations of the RAN node QQ300 (implemented using the structure of FIG. 16) will now be discussed with reference to the flow chart of FIGS. 12-13 according to some embodiments of inventive concepts. For example, modules may be stored in memory QQ304 of FIG. 16, and these modules may provide instructions so that when the instructions of a module are executed by respective RAN node processing circuitry QQ302, RAN node QQ300 performs respective operations of the flow chart. However, the operations of FIGS. 12-13 can be performed by any suitable entity (e.g., a communication device).

FIG. 12 illustrates an example of operations performed by a first entity in a communications network that includes a second entity, a third entity, and a fourth entity.

At block 1210, the first entity such as its processing circuitry QQ302 receives, via communication interface QQ306, configuration information associated with a reference signal, RS, to be transmitted by the second entity to the third entity. In some embodiments, receiving the configuration information includes receiving the configuration information from at least one of: the second entity; the third entity; and the fourth entity.

At block 1220, the first entity such as its processing circuitry QQ302 overhears, via communication interface QQ306, the RS using the configuration information.

At block 1230, the first entity such as its processing circuitry QQ302 transmits, via communication interface QQ306, a message to a fourth entity based on overhearing the RS.

At block 1240, the first entity such as its processing circuitry QQ202 determines a position of the first communication device based on a measurement of the SL PRS.

In some embodiments, the second entity is a first communication device, the third entity is a second communication device, and the RS is a sidelink, SL RS. In some examples, the SL RS is a SL positioning RS, PRS, the fourth entity is a location management function, LMF, and the message includes a measurement of the SL PRS.

In additional or alternative examples, the SL RS is a SL positioning RS, PRS, the first entity is configured to provide a location management function, LMF, and the message includes the position of the first communication device.

In additional or alternative examples, the first entity is at least one of: a network node; a positioning reference unit, PRU; and a third communication device.

In additional or alternative embodiments, the second entity is a communication device, the third entity is a network node, and the RS is an uplink, UL, reference signal, RS. In some examples, the UL RS is a UL sounding RS, SRS, the fourth entity is a location management function, LMF, and the message includes a measurement of the UL SRS.

In additional or alternative examples, the UL RS is a UL sounding RS, SRS, the first entity is configured to provide a location management function, LMF, and the message includes the position of the first communication device.

In additional or alternative examples, the network node is a first network node, and the first entity is at least one of: a second network node; a positioning reference unit, PRU; and a second communication device.

In additional or alternative embodiments, the configuration information includes an indication of a measurement gap during which to perform the overhearing.

FIG. 13 illustrates an example of operations performed by a first entity in a communications network that includes a second entity, a third entity, and a fourth entity.

At block 1310, the first entity such as its processing circuitry QQ202 transmits, via communication interface QQ306, configuration information to a second entity, the configuration information associated with a reference signal, RS, to be transmitted by the third entity to the fourth entity.

At block 1320, the first entity such as its processing circuitry QQ202 receives, via communication interface QQ306, a message from the second entity, the message including information associated with the second entity overhearing the RS using the configuration information.

At block 1330, the first entity such as its processing circuitry QQ202 determines a position of the first communication device based on the measurement of the SL PRS.

In some embodiments, the second entity is a network node, the third entity is a first communication device, the fourth entity is a second communication device, and the RS is a sidelink, SL RS. In some examples, the SL RS is a SL positioning RS, PRS, the first entity includes a location management function, LMF, and the message includes a measurement of the SL PRS.

In additional or alternative examples, the SL RS is a SL positioning RS, PRS, the second entity is configured to provide a location management function, LMF, and the message includes the position of the first communication device.

In additional or alternative examples, the network node is a first network node, and the first entity is at least one of: a second network node; and a third communication device.

In additional or alternative embodiments, the second entity is a first communication device, the third entity is a second communication device, the fourth entity is a network node, and the RS is an uplink, UL, reference signal, RS. In some examples, the UL RS is a UL sounding RS, SRS, the first entity includes a location management function, LMF, and the message includes a measurement of the SL PRS

In additional or alternative examples, the UL RS is a UL sounding RS, SRS, the second entity is configured to provide a location management function, LMF, and the message includes the position of the first communication device.

In additional or alternative examples, the network node is a first network node, and the first entity is at least one of: a second network node; and a third communication device.

In additional or alternative embodiments, the configuration information includes an indication of a measurement gap during which to perform the overhearing.

Various operations from the flow charts of FIGS. 12-13 may be optional with respect to some embodiments of RAN nodes and related methods.

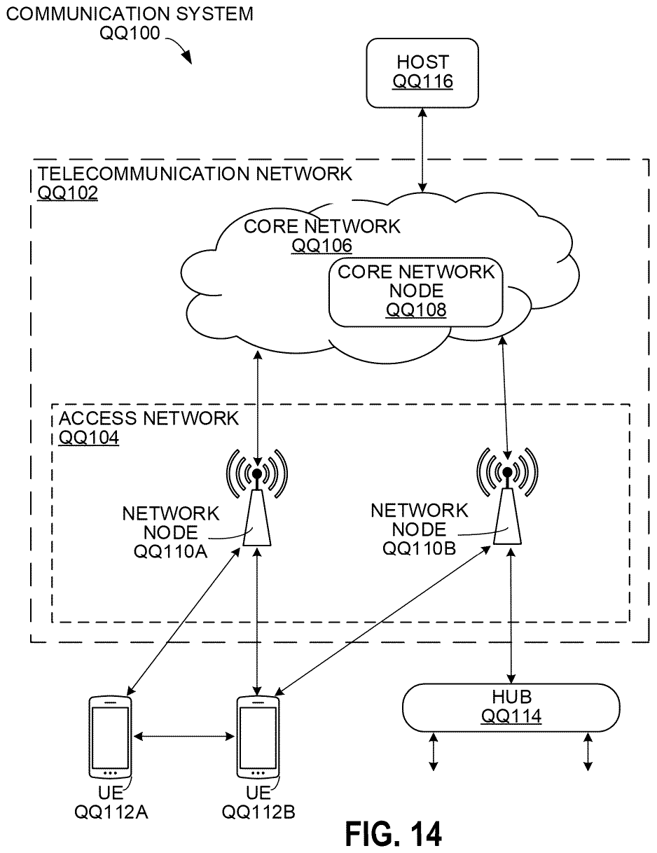

FIG. 14 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. Moreover, as will be appreciated by those of skill in the art, the network nodes QQ110 are not necessarily limited to an implementation in which a radio portion and a baseband portion are supplied and integrated by a single vendor. Thus, it will be understood that the network nodes QQ110 may include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes QQ110 facilitate direct or indirect connection of user equipment (UE), such as by connecting wireless devices QQ112a, QQ112b, QQ112c, and QQ112d (one or more of which may be generally referred to as UEs QQ112) to the core network QQ106 over one or more wireless connections. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service.

Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection.

Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

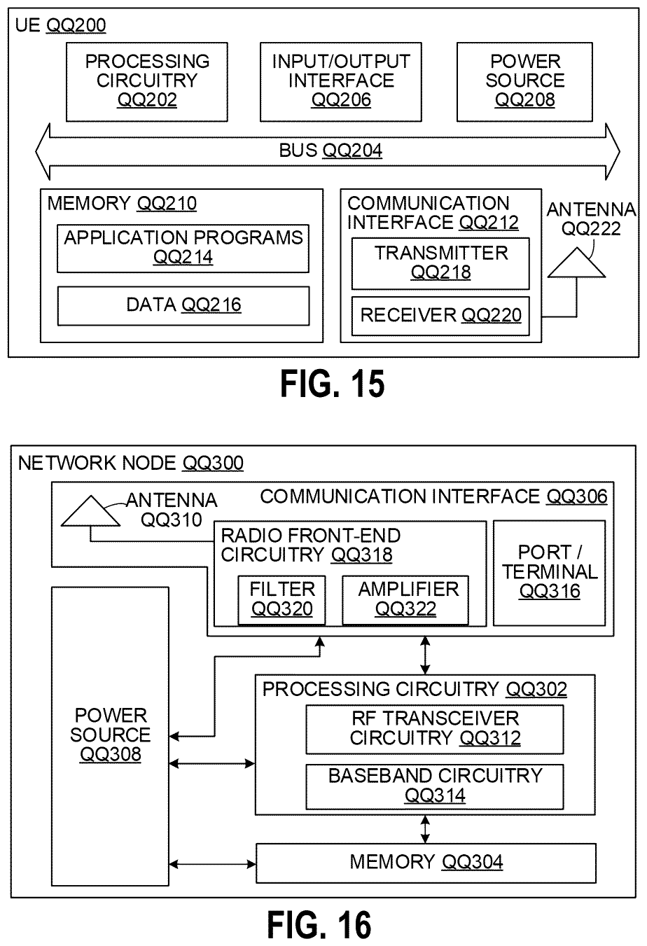

FIG. 15 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 16 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

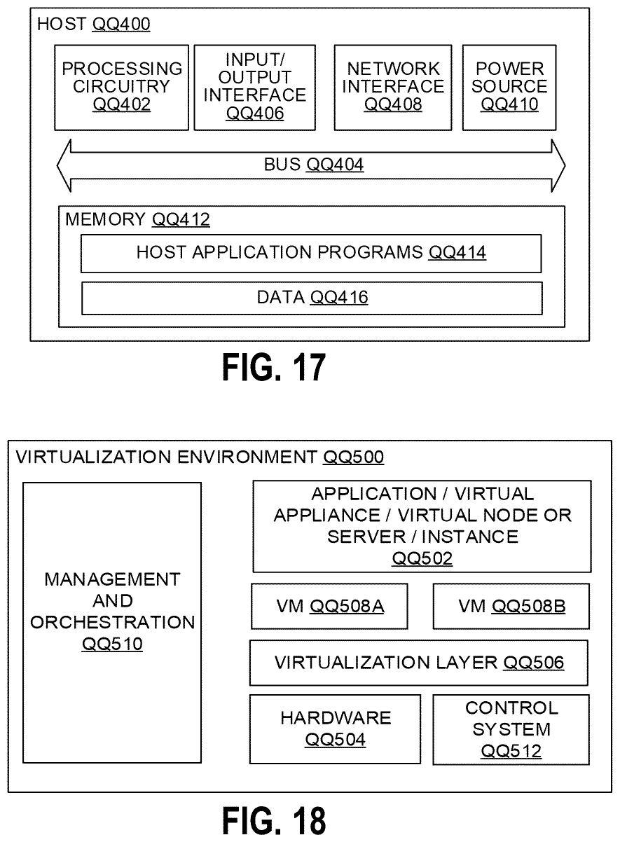

FIG. 17 is a block diagram of a host QQ400, which may be an embodiment of the host QQ116 of FIG. 14, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments.

Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization.

Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

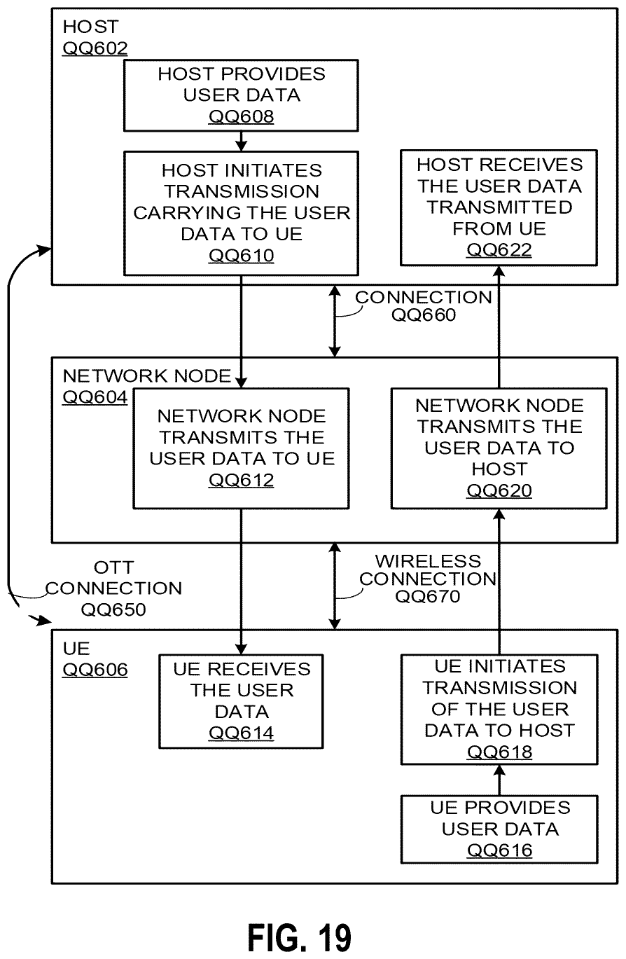

FIG. 19 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 14 and/or UE QQ200 of FIG. 15), network node (such as network node QQ110a of FIG. 14 and/or network node QQ300 of FIG. 16), and host (such as host QQ116 of FIG. 14 and/or host QQ400 of FIG. 17) discussed in the preceding paragraphs will now be described with reference to FIG. 19.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 14) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure.

Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may enable additional entities to overhear a reference signal for UL positioning. This can reduce reference signal overhead and/or improve positioning.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

1. A method of operating a first entity in a communications network that includes a second entity, a third entity, and a fourth entity, the method comprising:
   receiving (1210) configuration information associated with a reference signal, RS, to be transmitted by the second entity to the third entity;
   overhearing (1220) the RS using the configuration information; and transmitting (1230) a message to a fourth entity based on overhearing the RS.
2. The method of Embodiment 1, wherein receiving the configuration information comprises receiving the configuration information from at least one of:
   the second entity;
   the third entity; and
   the fourth entity.
3. The method of any of Embodiments 1-2, wherein the second entity is a first communication device,
   wherein the third entity is a second communication device, and
   wherein the RS is a sidelink, SL RS.
4. The method of Embodiment 3, wherein the SL RS is a SL positioning RS, PRS,
   wherein the fourth entity is a location management function, LMF, and
   wherein the message includes a measurement of the SL PRS.
5. The method of Embodiment 3, wherein the SL RS is a SL positioning RS, PRS,
   wherein the first entity is configured to provide a location management function, LMF,
   the method further comprising:
      determining (1240) a position of the first communication device based on a measurement of the SL PRS,
   wherein the message includes the position of the first communication device.
6. The method of any of Embodiments 3-5, wherein the first entity is at least one of:
   a network node;
   a positioning reference unit, PRU; and
   a third communication device.
7. The method of any of Embodiments 1-2, wherein the second entity is a communication device,
   wherein the third entity is a network node, and
   wherein the RS is an uplink, UL, reference signal, RS.
8. The method of Embodiment 7, wherein the UL RS is a UL sounding RS, SRS,
   wherein the fourth entity is a location management function, LMF, and
   wherein the message includes a measurement of the UL SRS.
9. The method of Embodiment 7, wherein the UL RS is a UL sounding RS, SRS,
   wherein the first entity is configured to provide a location management function, LMF,
   the method further comprising:
      determining (1240) a position of the first communication device based on a measurement of the UL SRS,
   wherein the message includes the position of the first communication device.
10. The method of any of Embodiments 7-9, wherein the network node is a first network node, and
   wherein the first entity is at least one of:
      a second network node;
      a positioning reference unit, PRU; and
      a second communication device.
11. The method of any of Embodiments 1-10, wherein the configuration information comprises an indication of a measurement gap during which to perform the overhearing.
12. A method of operating a first entity in a communications network that includes a second entity, a third entity, and a fourth entity, the method comprising:
   transmitting (1310) configuration information to a second entity, the configuration information associated with a reference signal, RS, to be transmitted by the third entity to the fourth entity; and
   receiving (1320) a message from the second entity, the message including information associated with the second entity overhearing the RS using the configuration information.
13. The method of Embodiment 12, wherein the second entity is a network node,
   wherein the third entity is a first communication device,
   wherein the fourth entity is a second communication device, and
   wherein the RS is a sidelink, SL RS.
14. The method of Embodiment 13, wherein the SL RS is a SL positioning RS, PRS,
   wherein the first entity includes a location management function, LMF, and
   wherein the message includes a measurement of the SL PRS.
15. The method of Embodiment 14, further comprising:
   determining (1330) a position of the first communication device based on the measurement of the SL PRS.
16. The method of Embodiment 13, wherein the SL RS is a SL positioning RS, PRS,
   wherein the second entity is configured to provide a location management function, LMF, and
   wherein the message includes the position of the first communication device.
17. The method of any of Embodiments 13-16, wherein the network node is a first network node, and
   wherein the first entity is at least one of:
      a second network node; and
      a third communication device.
18. The method of Embodiment 12, wherein the second entity is a first communication device,
   wherein the third entity is a second communication device,
   wherein the fourth entity is a network node, and
   wherein the RS is an uplink, UL, reference signal, RS.
19. The method of Embodiment 18, wherein the UL RS is a UL sounding RS, SRS,
   wherein the first entity includes a location management function, LMF, and
   wherein the message includes a measurement of the SL PRS.
20. The method of Embodiment 19, further comprising:
   determining (1330) a position of the first communication device based on the
21. The method of Embodiment 18, wherein the UL RS is a UL sounding RS, SRS,
   wherein the second entity is configured to provide a location management function, LMF, and
   wherein the message includes the position of the first communication device.
22. The method of any of Embodiments 18-21, wherein the network node is a first network node, and
   wherein the first entity is at least one of:
      a second network node; and
      a third communication device.
23. The method of any of Embodiments 12-22, wherein the configuration information comprises an indication of a measurement gap during which to perform the overhearing.
24. An entity (QQ200, QQ300), the entity comprising:
   processing circuitry (QQ202, QQ302); and
   memory (QQ310, QQ304) coupled to the processing circuitry and having instructions stored therein that are executable by the processing circuitry to cause the entity to perform operations comprising any of the operations of Embodiments 1-23.
25. A computer program comprising program code to be executed by processing circuitry (QQ202, QQ302) of an entity (QQ200, QQ300), whereby execution of the program code causes the entity to perform operations comprising any operations of Embodiments 1-23.
26. A computer program product comprising a non-transitory storage medium (QQ210, QQ304) including program code to be executed by processing circuitry (QQ302) of an entity (QQ200, QQ300), whereby execution of the program code causes the entity to perform operations comprising any operations of Embodiments 1-23.
27. A non-transitory computer-readable medium having instructions stored therein that are executable by processing circuitry (QQ202, QQ302) of an entity (QQ200, QQ300) to cause the entity to perform operations comprising any of the operations of Embodiments 1-23.
28. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
      transmitting (1310) configuration information to a second entity, the configuration information associated with a reference signal, RS, to be transmitted by the third entity to the fourth entity; and
      receiving (1320) a message from the second entity, the message including information associated with the second entity overhearing the RS using the configuration information.
29. The host of the previous embodiment, wherein:
   the processing circuitry of the host is configured to execute a host application that provides the user data; and
   the UE comprises processing circuitry configured to execute a client application associated with the host application to receive the transmission of user data from the host.
30. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs the following operations to transmit the user data from the host to the UE:
      transmitting (1310) configuration information to a second entity, the configuration information associated with a reference signal, RS, to be transmitted by the third entity to the fourth entity; and
      receiving (1320) a message from the second entity, the message including information associated with the second entity overhearing the RS using the configuration information.
31. The method of the previous embodiment, further comprising, at the network node, transmitting the user data provided by the host for the UE.
32. The method of any of the previous 2 embodiments, wherein the user data is provided at the host by executing a host application that interacts with a client application executing on the UE, the client application being associated with the host application.
33. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform the following operations to transmit the user data from the host to the UE:
      transmitting (1310) configuration information to a second entity, the configuration information associated with a reference signal, RS, to be transmitted by the third entity to the fourth entity; and
      receiving (1320) a message from the second entity, the message including information associated with the second entity overhearing the RS using the configuration information.
34. The communication system of the previous embodiment, further comprising:
   the network node; and/or
   the user equipment.
35. The communication system of the previous 2 embodiments, wherein:
   the processing circuitry of the host is configured to execute a host application, thereby providing the user data; and
   the host application is configured to interact with a client application executing on the UE, the client application being associated with the host application.
36. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform the following operations to receive the user data from the UE for the host:
      transmitting (1310) configuration information to a second entity, the configuration information associated with a reference signal, RS, to be transmitted by the third entity to the fourth entity; and
      receiving (1320) a message from the second entity, the message including information associated with the second entity overhearing the RS using the configuration information.
37. The host of the previous 2 embodiments, wherein:
   the processing circuitry of the host is configured to execute a host application, thereby providing the user data; and
   the host application is configured to interact with a client application executing on the UE, the client application being associated with the host application.
38. The host of the any of the previous 2 embodiments, wherein the initiating receipt of the user data comprises requesting the user data.
39. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs the following operations to receive the user data from the UE for the host:
      transmitting (1310) configuration information to a second entity, the configuration information associated with a reference signal, RS, to be transmitted by the third entity to the fourth entity; and
      receiving (1320) a message from the second entity, the message including information associated with the second entity overhearing the RS using the configuration information.
40. The method of the previous embodiment, further comprising at the network node, transmitting the received user data to the host.
41. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
      receiving (1210) configuration information associated with a reference signal, RS, to be transmitted by the second entity to the third entity;
      overhearing (1220) the RS using the configuration information; and
      transmitting (1230) a message to a fourth entity based on overhearing the RS.
42. The host of the previous embodiment, wherein the cellular network further includes a network node configured to communicate with the UE to transmit the user data to the UE from the host.
43. The host of the previous 2 embodiments, wherein:
   the processing circuitry of the host is configured to execute a host application, thereby providing the user data; and
   the host application is configured to interact with a client application executing on the UE, the client application being associated with the host application.
44. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs the following operations to receive the user data from the host:
      receiving (1210) configuration information associated with a reference signal, RS, to be transmitted by the second entity to the third entity;
      overhearing (1220) the RS using the configuration information; and
      transmitting (1230) a message to a fourth entity based on overhearing the RS.
45. The method of the previous embodiment, further comprising:
   at the host, executing a host application associated with a client application executing on the UE to receive the user data from the UE.
46. The method of the previous embodiment, further comprising:
   at the host, transmitting input data to the client application executing on the UE, the input data being provided by executing the host application,
   wherein the user data is provided by the client application in response to the input data from the host application.
47. A host configured to operate in a communication system to provide an over-the-top (OTT) service, the host comprising:
   processing circuitry configured to utilize user data; and
   a network interface configured to receipt of transmission of the user data to a cellular network for transmission to a user equipment (UE),
   wherein the UE comprises a communication interface and processing circuitry, the communication interface and processing circuitry of the UE being configured to perform the following operations to transmit the user data to the host:
      receiving (1210) configuration information associated with a reference signal, RS, to be transmitted by the second entity to the third entity;
      overhearing (1220) the RS using the configuration information; and
      transmitting (1230) a message to a fourth entity based on overhearing the RS.
48. The host of the previous embodiment, wherein the cellular network further includes a network node configured to communicate with the UE to transmit the user data from the UE to the host.
49. The host of the previous 2 embodiments, wherein:
   the processing circuitry of the host is configured to execute a host application, thereby providing the user data; and
   the host application is configured to interact with a client application executing on the UE, the client application being associated with the host application.
50. A method implemented by a host configured to operate in a communication system that further includes a network node and a user equipment (UE), the method comprising:
   at the host, receiving user data transmitted to the host via the network node by the UE, wherein the UE performs the following operations to transmit the user data to the host:
      receiving (1210) configuration information associated with a reference signal, RS, to be transmitted by the second entity to the third entity;
      overhearing (1220) the RS using the configuration information; and
      transmitting (1230) a message to a fourth entity based on overhearing the RS.
51. The method of the previous embodiment, further comprising:
   at the host, executing a host application associated with a client application executing on the UE to receive the user data from the UE.
52. The method of the previous embodiments, further comprising:
   at the host, transmitting input data to the client application executing on the UE, the input data being provided by executing the host application,
   wherein the user data is provided by the client application in response to the input data from the host application.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
AD Assistance Data
AMF Access and Mobility Management Function
AoA Angle of arrival
CP Cyclic prefix
CSI-RS Channel state information reference signals
DCI Downlink control information
DL Downlink
DRS Discovery Signal
DRX Discontinuous Reception
eDRX Extended DRX
eNB Evolved node B
FDD Frequency division duplex
FR1 Frequency range 1
FR2 Frequency range 2
FR3 Frequency range 3
gNB Next generation Node B (5G base station)
LMF Location management function
LMU Location measurement unit
NN Network node
NR New radio (5G)
PBCH Physical broadcast channel
PDCCH Physical downlink control channel
PDSCH Physical downlink shared channel
PRS Positioning reference signals
PRS-RSRP Positioning reference signals RSRP
PUCCH Physical uplink control channel
PUSCH Physical uplink shared channel
RAT Radio access technology
RRC Radio resource control
RRM Radio resource management
RSRP Reference symbol received power
RSRQ Reference symbol received quality
RSTD Reference signal time difference
RTT Round trip time
SCS Subcarrier spacing
SDT Small data transmission
SFN System frame number
SL SideLink
SMTC SSB measurement timing configuration
SRS Synchronization reference source
SSB Synchronization signal and PBCH block
TDD Time division duplex
TDOA Time difference of arrival
TRP Transmission and/or Reception Point
UE User equipment
UL Uplink
1x RTT CDMA2000 1x Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method of operating a first entity in a communications network that includes a second entity, a third entity, and a fourth entity, the method comprising:
receiving configuration information associated with a reference signal, RS, to be transmitted by the second entity to the third entity;
overhearing the RS using the configuration information; and
transmitting a message to a fourth entity based on overhearing the RS.

2. The method of claim 1, wherein receiving the configuration information comprises receiving the configuration information from at least one of:
the second entity;
the third entity; and
the fourth entity.

3. The method of claim 1 wherein the second entity is a first communication device,
wherein the third entity is a second communication device, and
wherein the RS is a sidelink, SL RS.

4. The method of claim 3, wherein the SL RS is a SL positioning RS, PRS,
wherein the fourth entity is a location management function, LMF, and
wherein the message includes a measurement of the SL PRS.

5. The method of claim 3, wherein the SL RS is a SL positioning RS, PRS,
wherein the first entity is configured to provide a location management function, LMF,
the method further comprising:
determining a position of the first communication device based on a measurement of the SL PRS,
wherein the message includes the position of the first communication device.

6. The method of claim 3, wherein the first entity is at least one of:
a network node;
a positioning reference unit, PRU; and
a third communication device.

7. The method of claim 1, wherein the second entity is a communication device,
wherein the third entity is a network node, and
wherein the RS is an uplink, UL, reference signal, RS.

8. The method of claim 7, wherein the UL RS is a UL sounding RS, SRS,
wherein the fourth entity is a location management function, LMF, and
wherein the message includes a measurement of the UL SRS.

9. The method of claim 7, wherein the UL RS is a UL sounding RS, SRS,
wherein the first entity is configured to provide a location management function, LMF,
the method further comprising:
determining a position of the first communication device based on a measurement of the UL SRS,
wherein the message includes the position of the first communication device.

10. The method of claim 7, wherein the network node is a first network node, and
wherein the first entity is at least one of:
a second network node;
a positioning reference unit, PRU; and
a second communication device.

11. The method of claim 1, wherein the configuration information comprises an indication of a measurement gap during which to perform the overhearing.

12. A method of operating a first entity in a communications network that includes a second entity, a third entity, and a fourth entity, the method comprising:
transmitting configuration information to a second entity, the configuration information associated with a reference signal, RS, to be transmitted by the third entity to the fourth entity; and
receiving a message from the second entity, the message including information associated with the second entity overhearing the RS using the configuration information.

13. The method of claim 12, wherein the second entity is a network node,
wherein the third entity is a first communication device,
wherein the fourth entity is a second communication device, and
wherein the RS is a sidelink, SL RS.

14. The method of claim 13, further comprising determining a position of the first communication device,
wherein the SL RS is a SL positioning RS, PRS,
wherein the first entity includes a location management function, LMF,
wherein the message includes a measurement of the SL PRS, and
wherein the position of the first communication device is determined based on the measurement of the SL PRS.

15. (canceled)

16. The method of claim 13, wherein the SL RS is a SL positioning RS, PRS,
wherein the second entity is configured to provide a location management function, LMF, and
wherein the message includes the position of the first communication device.

17. The method of claim 13, wherein the network node is a first network node, and
wherein the first entity is at least one of:
a second network node; and
a third communication device.

18. The method of claim 12, wherein the second entity is a first communication device,
wherein the third entity is a second communication device,
wherein the fourth entity is a network node, and
wherein the RS is an uplink, UL, reference signal, RS.

19. The method of claim 18, further comprising determining a position of the first communication device.
wherein the UL RS is a UL sounding RS, SRS,
wherein the first entity includes a location management function, LMF,
wherein the message includes a measurement of the SL PRS, and
wherein the position of the first communication device is determined based on the measurement of the UL SRS.

20. (canceled)

21. The method of claim 18, wherein the UL RS is a UL sounding RS, SRS,
wherein the second entity is configured to provide a location management function, LMF, and
wherein the message includes the position of the first communication device.

22. The method of claim 18, wherein the network node is a first network node, and
wherein the first entity is at least one of:
a second network node; and
a third communication device.

23-27. (canceled)
